(19) United States
(12) Patent Application Publication
(10) Pub. No.: US 2018/0012282 A1
(43) Pub. Date: Jan. 11, 2018

(54) IMAGE-BASED SHOPPING SYSTEM

(71) Applicant: Wal-Mart Stores, Inc., Bentonville, AR (US)

(72) Inventors: Todd D. Mattingly, Bentonville, AR (US); Matthew A. Jones, Bentonville, AR (US); David Tovey, Rogers, AR (US)

(21) Appl. No.: 15/646,204

(22) Filed: Jul. 11, 2017

Related U.S. Application Data
(60) Provisional application No. 62/360,716, filed on Jul. 11, 2016.

(51) Int. Cl. G06Q 30/06; G06T 11/20; G06K 9/62; G06F 3/0481; G06F 3/0484; G06F 3/0482

(52) U.S. Cl. CPC G06Q 30/0627; G06T 11/20; G06Q 30/0641; G06Q 30/0621; G06K 9/6215; G06K 9/6202; G06F 3/04845; G06F 3/0482; G06F 3/04817

(57) ABSTRACT

In some embodiments, apparatuses and methods are provided herein useful to providing an image-based shopping system. In some embodiments, a system for helping a customer find a desired product based on an image includes an electronic input device configured to receive, from the customer, the image, and a control circuit coupled to the electronic user input device and configured to identify one or more items in the image, identify, from a product data structure, a product that is similar to at least one of the one or more items in the image, and present, via an electronic display device, the product and an option to purchase the product.

### RELATED APPLICATION(S)

This application claims the benefit of U.S. Provisional Application No. 62/360,716, filed Jul. 11, 2016, which is incorporated herein by reference in its entirety.

### TECHNICAL FIELD

This invention relates generally to a shopping system and, more particularly, to an image-based shopping system.

### BACKGROUND

Traditional computer-based shopping systems (e.g., online shopping systems) allow customers to search for products using search terms (e.g., key words, phrases, operators, etc.) and menus (e.g., dropdown menus). While such search methods can produce products that customers desire, some customers may find these methods cumbersome, difficult, and error prone. For example, some customers may have trouble formulating search terms that yield the desired results or find it time consuming to complete a sufficient number of menus to narrow product choices to a reasonable number. Consequently, a need exists for alternative search methods that can overcome some or all of these problems.

### BRIEF DESCRIPTION OF THE DRAWINGS

Disclosed herein are embodiments of systems, apparatuses, and methods pertaining an image-based shopping system. This description includes drawings, wherein:

FIG. 1 depicts a web browser presenting an example image-based shopping graphical user interface (GUI) 100 that allows a customer to provide an image as a search query, according to some embodiments;

FIG. 2 depicts a web browser presenting an example image-based shopping graphical user interface (GUI) 200 that allows a customer to refine a search based on an image, according to some embodiments;

FIG. 3 is a block diagram of an image-based shopping system 300, according to some embodiments;

FIG. 4 is a flow chart depicting example operations for helping a customer find a desired product based on an image, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to providing an image-based shopping system. In some embodiments, a system for helping a customer find a desired product based on an image includes an electronic input device configured to receive, from the customer, the image and a control circuit coupled to the electronic user input device and configured to identify one or more items in the image, identify, from a product data structure, a product that is similar to at least one of the one or more items in the image, and present, via an electronic display device, the product and an option to purchase the product.

As previously discussed, current computer-based shopping systems allow for only limited searching options. Customers searching for products using these systems may find such current systems cumbersome, difficult, and error prone. For example, some customers may have trouble formulating search terms that yield the desired results or find it time consuming to complete a sufficient number of menus to narrow product choices to a reasonable number. Embodiments of the systems, methods, and apparatuses described herein allow customers to search for products (e.g., products offered by a retailer online or through an in-store computer-based system) using images. For example, a customer can provide an image to an image-based shopping system and the image-based shopping system can return products offered for sale that match or are otherwise similar to items in the image. Additionally, some embodiments allow customers to augment image-based searches with traditional and menus. As one example, a customer can provide an image then use search terms or menus to further specify the type of product for which they are searching.

As a use case, a customer can take capture an image of something that he or she would like to purchase on his or her phone. The customer can then upload the image (e.g., via a web browser or dedicated application) to an image-based processing system. The image-based processing system can then find one or more products that match what the customer would like to purchase and transmit information relating to the one or more products to the customer's phone. The customer can then purchase the one or more products via the phone. Such a system can streamline the shopping process and make it easier for customers to locate, and purchase, products.

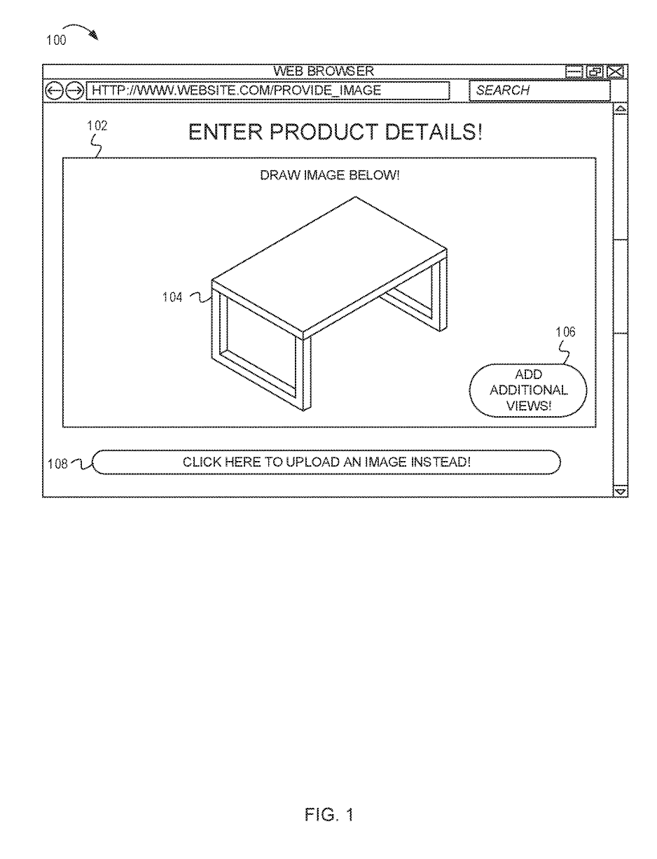

FIG. 1 depicts a web browser presenting an example image-based shopping GUI 100 that allows a customer to provide an image as a search query, according to some embodiments. The GUI 100 can be presented on any suitable computing device (e.g., via a browser on a computer or mobile device, via an application on a computer or mobile device, etc.). As depicted in FIG. 1, the GUI 100 is presented via browser. The GUI 100 includes an image creation section 102 in which a customer can draw an image of a product that they would like to purchase. As depicted in FIG. 1, the customer has opted to draw an image of a table 104, the product that he or she would like to purchase. The method by which the customer draws the image is dependent upon the hardware and/or software of the computing device presenting the GUI 100. Specifically, the method by which the customer can draw the image is based on a type of user input device included with the computing device. For example, if the computing device includes a touchscreen or touchpad, the customer can draw the image directly on the touchscreen or touchpad using his or her finger or a stylus. As another example, if the computing device includes a pointing device such as a mouse, the customer can use the mouse to draw the image. The software available to the user device can also determine how a customer can provide an image. For example, if the user device includes a computer-aided design (CAD) application, the user can create an image using the CAD application. While some examples are provided above, the image-based shopping system can utilize any suitable user input device (e.g., a keyboard, a mouse, a touchpad, a trackpad, a touchscreen, a stylus, a scanner, a bus, a camera, etc.).

In addition to providing the image of the table 104, in some embodiments the user can provide additional views of the image. For example, the GUI 100 includes an “add additional views button” 106. Selection of the “add additional views button” 106 allows the user to draw (or otherwise provide) additional images. For example, the image of the table 104 is an isometric view. The customer can enhance the search, for example, by providing a front, side, or top view.

In some embodiments, customers can provide images by uploading (or copying and pasting, dragging and dropping, etc. an image) via the GUI 100. In such embodiments, the GUI 100 can include an “upload button” 108. Selection of the “upload button” 108 allows the customer to provide a preexisting image to the image-based shopping system. In such embodiments, the customer utilizes the user input device to upload the image. The preexisting image can be a computer file (e.g., a photograph or drawing file or digital image such as a picture) or a link (e.g., a uniform resource locator (URL) or file path). The customer can provide the image by providing a file path, a URL, or dragging and dropping the image into the GUI 100.

In some embodiments, the GUI 100 allows the customer to provide an image by both uploading an image and drawing an image. For example, the customer can upload an image and draw an additional view of an item in the image, or the customer can upload an image and then modify the image by drawing on top of the image.

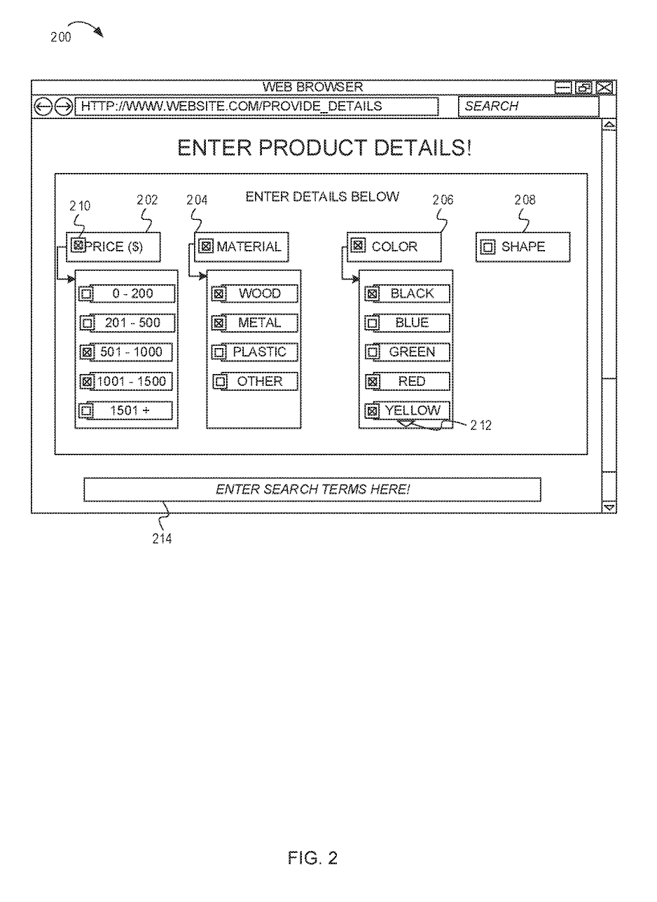

While FIG. 1 and the related text provide an overview of providing an image via a GUI, FIG. 2 and the related text provide an overview of modifying or refining an image-based search using search terms and/or menus.

FIG. 2 depicts a web browser presenting an example image-based shopping GUI 200 that allows a customer to refine a search based on an image, according to some embodiments. In some embodiments, after the customer provides the image (as described with reference to FIG. 1), the customer can modify and/or refine the search using menus and search terms. The example GUI 200 depicted in FIG. 2 provides both menus and the ability to enter search terms. The GUI 200 includes multiple dropdown menus: a first menu 202, a second menu 204, a third menu 206, and a fourth menu 208. Each menu includes choices from different categories. In the example depicted in FIG. 2, the first menu 202 includes a selection of prices, the second menu 204 includes a selection of materials, the third menu 206 includes a selection of colors, and the fourth menu includes a selection of shapes. The categories can be the same regardless of the image, or the categories some (or all) of the categories can change dependent on the image (e.g., an image of a chair may prompt presentation of different categories than an image of a computer). If a menu includes a greater number of values than can be accommodated within the GUI 200, the menu can include a “navigation button” 212. Selection of the “navigation button” 212 scrolls through the values within the associated menu.

The customer can choose values from the menus to refine and/or modify his or her search. For example, as depicted in FIG. 2 and continuing the example from FIG. 1, the customer has refined and/or modified his or her search for a table by indicating that he or she is interested in tables that 1) range in price from $500 to $1,500, 2) are made of wood and/or metal, and 3) are black, red, and/or yellow. Each menu includes a “selection button” 210. Selection of a “selection button” 210 causes the associated menu to collapse and/or expand. As depicted in FIG. 2, the first menu 202, the second menu 204, and the third menu 206 are expanded, while the fourth menu 208 is collapsed. In addition to the menus, the GUI 200 includes a search bar 214. The customer can modify and/or refine his or her search by inserting search terms into the search bar 214.

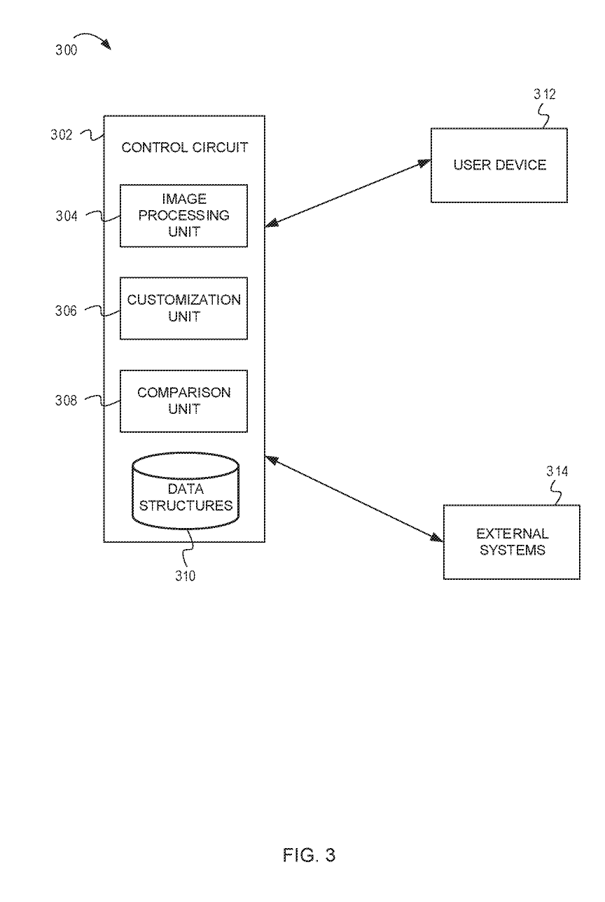

While FIGS. 1 and 2 depict example GUIs of an image-based shopping system, FIG. 3 and the related text describe the image-based shopping system in greater detail.

FIG. 3 is a block diagram of an image-based shopping system 300, according to some embodiments. The system 300 includes a control circuit 302, a user device 312, and, in some embodiments, external systems 314. The user device 312 can be any suitable computing device capable of receiving user input from a customer. The user device 312 is in communication with the control circuit 302. The user device 312 can be local or remote from the control circuit 302. For example, the user device 312 can be linked directly to the control circuit 302 or communicate with the control circuit via a network (e.g., a local area network (LAN) or a wide area network (WAN), such as the Internet). The user device 312 transmits the image to the control circuit 302.

The control circuit 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein.

By one optional approach the control circuit 302 operably couples to a memory. The memory may be integral to the control circuit 302 or can be physically discrete (in whole or in part) from the control circuit 302 as desired. This memory can also be local with respect to the control circuit 302 (where, for example, both share a common circuit board, chassis, power supply, and/or housing) or can be partially or wholly remote with respect to the control circuit 302 (where, for example, the memory is physically located in another facility, metropolitan area, or even country as compared to the control circuit 302).

This memory can serve, for example, to non-transitorily store the computer instructions that, when executed by the control circuit 302, cause the control circuit 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 302 includes an image processing unit 304, a customization unit 306, a comparison unit 308, and data structures 310. After the control circuit 302 receives the image from the user device 312, the image processing unit 304 performs image processing on the image. The image processing unit 304 can perform any operations suitable to identify items in the image. For example, the image processing unit 304 can perform contrast enhancement, dynamic range reduction, object recognition, etc. The image processing unit 304 processes the image to identify one or more items in the image. In some embodiments, the image processing unit can process the image for identifiers such as names, bar codes, QR codes, etc.

After the image processing unit 304 processes the image, the comparison unit 308 compares the items in the image with products (e.g., products offered for sale by a retailer). In some embodiments, the data structures 310 include information about the products. For example, the data structures 310 can include a listing of the products, image processing information about the products, prices for the products, availability of the products, indications of products that are similar to one another, etc. The comparison unit 308 utilizes the data structures 310 to identify a product (or multiple products) that are similar to an item (or multiple items) in the image. If the comparison unit 308 is able to identify a product that is a match to the item, the comparison unit provides that product for presentation on the user device 312. The comparison unit 308 can determine that a product is matched based on matching criteria. For example, a product may be a match if it meets a threshold number of the criteria. The comparison unit 308 can also provide information associated with the product (e.g., a price, availability, dimensions, etc.) for presentation on the user device 312. Additionally, the comparison unit can identify other products that are similar to the identified product and provide those products for presentation on the user device 312. The user device 312 presents an offer to the customer to purchase the product.

If the comparison unit 308 is unable to find a product that appears to be a match (e.g., a threshold number of the criteria are not met), the comparison unit can identify items that are close to the item and provide those products for presentation on the user device 312. The system 300 causes the user device 312 to present an offer to purchase the item(s). Additionally, or alternatively, the user device 312 can ask the customer if he or she would like to have a product made that matches the image. In such embodiments, the customization unit can analyze the image and prepare a mock-up of a custom product (e.g., diagram, blueprint, schematic, dimensions, qualities, colors, materials, etc.) matching the customer's image. The mock-up can include a virtual rendition of the product. The customization unit 306 transmits the mock-up to the external systems 314. The external systems can be associated with a manufacturer (e.g., a third party) or a retailer associated with the image-based shopping system if the retailer has the ability to produce a custom product. The customization unit 306, or in some embodiments, the external systems 314, can provide an estimate as to the cost of the custom product, manufacturing time, feasibility, etc. The control circuit 302 transmits this estimate to the user device 312 for presentation.

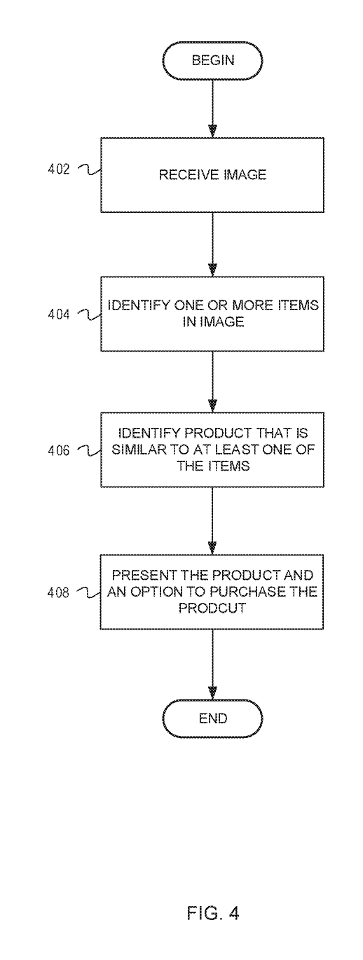

While FIG. 3 and the related text describe a system for conducting image-based shopping, FIG. 4 and the related text describe example operations for an image-based shopping system.

FIG. 4 is a flow chart depicting example operations for helping a customer find a desired product based on an image, according to some embodiments. The flow begins at block 402.

At block 402, an image is received. For example, an image-based shopping system can receive the image. The image-based shopping system can receive the image from a user input device. The user input device is associated with a user device, such as a computer, a tablet, a mobile device, or any other suitable computing device. The user device can present a GUI through which a customer interacts with the image-based shopping system. The user device can present the GUI via a browser or a dedicated application executing on the user device. The image can be a photograph, a drawing, a computer-aided design (CAD) sketch, etc. The flow continues at block 404.

At block 404, one or more items in the image are identified. For example, the image-based shopping system can identify the one or more items. The image-based shopping system can identify the items using any suitable image recognition technology. For example, the image-based shopping system can process the image by removing extraneous portions from the image, such as extraneous shapes, colors, items, etc. After removing the extraneous portions from the image, the image-based shopping system can identify the one or more items based on attribute information included in the image. The attribute information can include one or more of height, width, color, texture, material, style, etc. The items in the image are potential products that the customer would like to purchase. The flow continues at block 406.

At block 406, a product that is similar to at least one of the items is identified. For example, the image-based shopping system identifies the product. In some embodiments, the image-based shopping system identifies the product by referencing a data structure. The data structure can include products offered for sale by a retailer, as well as information associated with each of the products. The flow continues at block 408.

At block 408, the product is presented to the customer along with an option to purchase the product. For example, the user device can present the product and an offer to purchase the product. Additionally, the user device can present information associated with the product, as well as similar products in which the customer might be interested. In some embodiments, the customer can purchase the item via the user device and the transaction can be completed via the user device and the image-based shopping system.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

In some embodiments, a system for helping a customer find a desired product based on an image includes an electronic input device configured to receive, from the customer, the image, and a control circuit coupled to the electronic user input device and configured to identify one or more items in the image, identify, from a product data structure, a product that is similar to at least one of the one or more items in the image, and present, via an electronic display device, the product and an option to purchase the product.

In some embodiments, a corresponding method performed by the system comprises receiving, via an electronic user input device, an image, identifying, from a product data structure, a product that is similar to at least one of the one or more items in the image, and presenting, via an electronic display device, the product and an option to purchase the product.

What is claimed is:

1. A system for helping a customer find a desired product based on an image, the system comprising:
an electronic user input device configured to receive, from the customer, the image; and
a control circuit in communication with the electronic user input device and configured to,
identify, based on attribute information for the image, one or more items in the image;
identify, from a product data structure, a product that is similar to at least one of the one or more items in the image;
present, via an electronic display device, the product and an option to purchase the product;
generate, based on the image, a virtual rendition of the one or more items; and
receive, via the user input device, customer input to modify the virtual rendition of the one or more items.

2. The system of claim 1, wherein the identification of a product that is similar to at least one of the one or more items is based on a comparison between the one or more items and products stored in the product data structure.

3. The system of claim 1, wherein the attribute information for the image includes one or more of height, width, color, texture, materials, and style.

4. The system of claim 3, wherein the control circuit is further configured to:
remove extraneous portions from the image.

5. The system of claim 4, wherein the customer input to modify the virtual rendition of the one or more items includes at least one of selection of options from a menu, selection of predefined shapes, and creation of shapes.

6. The system of claim 1, wherein the image is one or more of a drawing, a picture, a computer generated file, and a digital image.

7. The system of claim 1, wherein the control circuit is further configured to:
present, via the display device, an option to create a custom product.

8. The system of claim 1, wherein the image is based on an image drawn on the user input device.

9. The system of claim 1, wherein the user input device is one or more of a keyboard, a mouse, a touchpad, a trackpad, a touchscreen, a stylus, a scanner, a bus, and a camera.

10. The system of claim 1, wherein the product data structure includes a listing of products and one or more of attributes of each one of the products, a price of each one of the products, an availability of each one of the products, and an indication of products similar to each one of the products.

11. A method of helping a customer find a desired product based on an image, the method comprising:
receiving, via an electronic user input device, an image;
identifying, based on attribute information for the image, one or more items in the image;
identifying, from a product data structure, a product that is similar to at least one of the one or more items in the image;
presenting, via an electronic display device, the product and an option to purchase the product;
generating, based on the image, a virtual rendition of the one or more items; and
receiving, via the user input device, customer input to modify the virtual rendition of the one or more items.

10. The method of claim 11, wherein the identifying the product that is similar to at least one of the one or more items is based on a comparison between the one or more items and products stored in the product data structure.

13. The method of claim 11 wherein the attribute information for the image includes one or more of height, width, color, texture, materials, and style.

14. The method of claim 13, further comprising:
removing extraneous portions of the image.

11. The method of claim 14, wherein the customer input to modify the virtual rendition of the one or more items includes at least one of selection of options from a menu, selection of predefined shapes, and creation of shapes.

12. The method of claim 11, wherein the image is one or more of a drawing, a picture, a computer generated file, and a digital image.

13. The method of claim 11, further comprising:
presenting, via the display device, an option to create a custom product.

14. The method of claim 11, wherein the image is based on an image drawn on the user input device.

15. The method of claim 11, wherein the user input device is one or more of a keyboard, a mouse, a touchpad, a trackpad, a touchscreen, a stylus, a scanner, a bus, and a camera.

16. The method of claim 11, wherein the product data structure includes a listing of products and one or more of attributes of each one of the products, a price of each one of the products, an availability of each one of the products, and an indication of products similar to each one of the products.
